(19) United States
(12) Patent Application Publication
(10) Pub. No.: US 2026/0300646 A1
(43) Pub. Date: Oct. 1, 2026

(54) SYSTEMS AND METHODS FOR STORY PROFILE PERSONALIZATION

(71) Applicant: Philip Dana Marshall, Portland, OR (US)

(72) Inventor: Philip Dana Marshall, Portland, OR (US)

(21) Appl. No.: 19/632,047

(22) Filed: Mar. 27, 2026

Related U.S. Application Data
(60) Provisional application No. 63/780,088, filed on Mar. 28, 2025.

(51) Int. Cl. G06F 40/40; G06F 40/279

(52) U.S. Cl. CPC G06F 40/40; G06F 40/279

(57) ABSTRACT

Systems and methods are herein provided for story profile personalization. In one example, a story recommendation system comprises: a processor communicably coupled to non-transitory memory storing instructions that when executed cause the processor to: receive one or more works; determine story profiles of the one or more works; determine, for a user, a user palette profile; and generate a recommendation for a work of the one or more works for the user based on the story profiles and the user palette profile.

### CROSS-REFERENCE TO RELATED APPLICATIONS

The present application claims priority to U.S. Provisional Application No. 63/780,088, entitled “SYSTEMS AND METHODS FOR STORY PROFILE PERSONALIZATION”, and filed on Mar. 28, 2025. The entire contents of the above-listed application are hereby incorporated by reference for all purposes.

### FIELD

Embodiments of the subject matter disclosed herein relate to characterizing written works and user engagement for recommendation of works to users.

### BACKGROUND AND SUMMARY

Reading has been a source of entertainment for a very long time. Literature, or any collection of written work, may comprise novels, short stories, poems, and more. Works of literature are frequently provided through a publisher; however self-published works are common as well. In recent times, people more commonly consume such works in spoken word form, for example via audiobook. The amount of existing works is vast, and more works are published every day.

Although a large amount of works is generated, individual consumers may gravitate towards certain types of works, and other types may not be relevant to them. Of the certain types of works that an individual gravitates towards, the content that the individual actually chooses to engage with may be considerably smaller. With the generation and proliferation of such a large amount of content, especially with the advent of websites and applications that make self-publishing easier, it becomes harder for users to sift through all the content and find works of interest to them.

Thus, the inventors herein have recognized the aforementioned issues and developed systems and methods that at least partially address these issues. In one example, methods and system are herein disclosed for a recommendation system that utilizes mathematical vectorization techniques to characterize available works and user engagements to recommend one or more specific works to an individual user. In this way, recommendations may be tailored to individual users based on how the user engages with works and the types of works that they gravitate towards, reducing information overload for users.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present disclosure will be better understood from reading the following description of non-limiting embodiments, with reference to the attached drawings, wherein below:

FIG. 1 shows a block diagram of an exemplary characterization and recommendation, in accordance with one or more embodiments of the present disclosure;

FIG. 2 shows a high-level flowchart illustrating a method for user-specific recommendation, in accordance with one or more embodiments of the present disclosure;

FIG. 3 shows a flowchart illustrating a method for mathematical vectorization of story attributes, in accordance with one or more embodiments of the present disclosure; and

FIG. 4 shows a flowchart illustrating a method for recommending works to a user based on mathematical vectorization.

FIG. 5 shows a flowchart illustrating a method for recommending a work based on a user request.

### DETAILED DESCRIPTION

The following description relates to various embodiments of a characterization and recommendation system. In particular, systems and methods for characterizing one or more story attributes/dimensions and characterizing a user's palette for recommending works to the user. The systems and methods utilize mathematical vectorization of these dimensions in order to generate the recommendations.

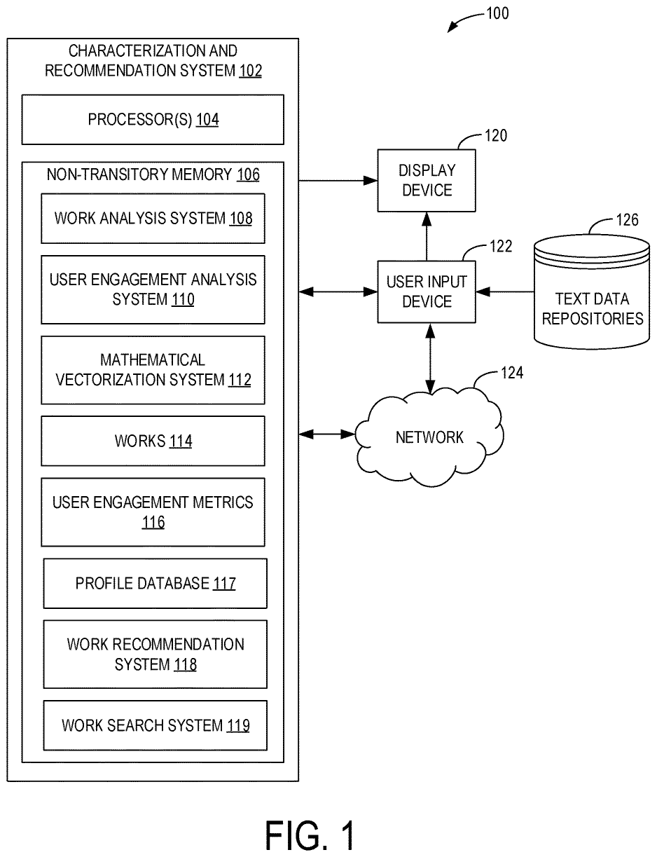

Starting now to the figures, FIG. 1 shows a story profile personalization system 100. The system 100 may comprise a characterization and recommendation system 102, in accordance with an embodiment of the present disclosure. In some embodiments, at least a portion of the characterization and recommendation system 102 is disposed at a device (e.g., an edge device, server, etc.). The characterization and recommendation system 102 may include one or more processors 104 configured to execute machine readable instructions stored in non-transitory memory 106. Processor(s) 104 may be single core or multi-core, and the programs executed thereon may be configured for parallel or distributed processing. In some embodiments, the processor(s) 104 may optionally include individual components that are distributed throughout two or more devices, which may be remotely located and/or configured for coordinated processing. In some embodiments, one or more aspects of the processor(s) 104 may be virtualized and executed by remotely-accessible networked computing devices configured in a cloud computing configuration.

Non-transitory memory 106 may store a work analysis system 108 and user engagement analysis system 110. The work analysis system 108 may be configured to define a plurality of dimensions or attributes for each of one or more works 114 and to determine, based on the plurality of dimensions, a story profile for each work. It should be appreciated that while the system 100 is herein dubbed a story personalization system, other types of written works with or without corresponding audio narrations thereof, such as short stories and poems, may also be analyzed by the system. The plurality of dimensions may include story content based dimensions or attributes and narration format based dimensions or attributes. The story content based dimensions may relate to the text of the story, with respect to how the content therein is conveyed by the author. The narration format based dimensions may relate to how an audio narration of the corresponding text is delivered.

For example, the story content based dimensions may include genre, subgenres (e.g., as included in smart tags), mood/tone (e.g., dark, lighthearted, gritty, etc.), protagonist attributes (e.g., age, profession, hero/anti-hero, moral alignment, defining characteristics, etc.), point of view, narrative structure (e.g., linear, nonlinear, multi-timeline, epistolary, etc.), themes (e.g., identity crisis, survivor, forbidden love, revenge, etc.), setting (e.g., time period, social setting, physical location), and target demographic (e.g., young adult, adult, middle grade, etc.).

The narration format based dimensions may include audio narration style (e.g., single narrator, multi-cast, full audio drama, dual narrator, etc.), audio narrator type (e.g., human-like, AI-generated, male, female, a particular accent/dialect, etc.), narration speed and style (e.g., slow-paced, energetic, dramatic, deadpan, whispered, etc.), sound design (e.g., minimal extraneous sounds, music-enhanced, full sound effects, etc.), and vocal performance style (e.g., conversational, storytelling, theatrical, etc.).

In some examples, the work analysis system 108 may employ one or more trained machine learning models to extract from an inputted work the plurality of dimensions for that inputted work. For example, a machine learning model may be trained to ingest a written work and a corresponding audio narration thereof and analyze the written work to determine story content dimensions and analyze the audio narration thereof to determine narration format dimensions. In other examples, the work analysis system 108 may determine the plurality of dimensions based on user inputs for the corresponding work. For example, an author may upload a work via a user input device 122 and may indicate the plurality of dimensions for the uploaded work.

The trained machine learning model deployed by the work analysis system 108 to extract story dimensions from an inputted work constitutes a specific, technically defined process that operates on concrete, multi-modal input data to produce a structured output. Specifically, the machine learning model is trained to ingest both a written work and a corresponding audio narration thereof as inputs and to perform distinct analytical operations on each modality: analyzing the written text to extract content-based dimensions such as genre, narrative structure, protagonist attributes, themes, and target demographic, and separately analyzing the audio narration to extract narration-based dimensions such as audio narration style, narrator type, narration speed and style, sound design, and vocal performance style. This multi-modal ingestion and analysis process represents a specific technical improvement over prior art systems that analyze only a single modality, as it enables the generation of a more complete and technically precise story profile vector that captures both the literary and auditory characteristics of a work. The machine learning model produces a concrete output, in this instance a structured set of dimension values, which is then consumed by the mathematical vectorization system 112 to generate the story profile vector, thereby forming a specific, technically defined pipeline from raw multi-modal input data to a structured numerical representation. The technical effect of this pipeline is a more accurate and comprehensive story profile that enables more precise vector similarity computations downstream, resulting in a measurable improvement in recommendation quality.

The user engagement analysis system 110 may be configured to determine, based one or more engagement metrics 116, a user palette profile. The user palette profile may be determined based on one or more user engagement dimensions and story profiles of one or more positively engaged with works. The user engagement dimensions may be determined based on engagement metrics 116, which may comprise community metrics and work-specific metrics. The community metrics may comprise popularity of a work, overall completion rate, number of total replays amongst all users, community-curated lists of works, and the like. The user-specific metrics may comprise the discoverability of works the user engages with (e.g., trending/popular works or hidden gems), listening patterns including time-of-day listening patterns, mood-based listening habits, and listening session behavior (e.g., binge listener vs casual listener), and metrics specific to a given work such as completion rate, rating, number of replays, reviews, and the like. The community metrics and the work-specific metrics both may inform the user palette profile, which may indicate the types of work that the user likes, dislikes, engages with at certain times of day, etc. The defined types of work may include both individual and group-based dimensions as herein described. For example, individual story dimensions like young adult works vs middle grade works may be considered as well as grouped story dimensions such as “young adult work featuring a dystopian rebel”.

As an example, works for which a user left a positive review, highly rated, replayed, or finished may be determined to be positively engaged with while works for which a user left a negative review, rated low (e.g., below three out of five stars, in the example of a standard five-star review system), skipped sections, or did not finish may be determined to negatively engaged with works. As noted above, each story profile may comprise a plurality of story dimensions including content-based dimensions and narration-based dimensions which may be associated with the engagement dimensions in order to determine the user palette profile. For example, a user palette profile may suggest that the user gravitates towards young adult fantasy and dystopian books with a strong female lead that are written in first or third person and also tends to listen to contemporary romance works in the morning hours. As will be described herein, the user engagement dimensions as well as the dimensions of works that were positively engaged with may be represented numerically via mathematical vectorization in order for the system to generate one or more recommendations that are user-specific.

The non-transitory memory 106 may further comprise a mathematical vectorization system 112, a profile database 117, a work recommendation system 118, and a work search system 119. The mathematical vectorization system 112 may be configured to convert the identified story dimensions and user engagement dimensions into representative numerals. In some examples, the mathematical vectorization system 112 may work in conjunction with the work analysis system 108 and/or the user engagement analysis system 110 to represent the defined story dimensions and/or user engagement dimensions numerically in vectors. The story profiles and/or the user palette profiles may thus comprise embedded vectors, each with a plurality of dimension values that represent the defined plurality of story dimensions/engagement dimensions. In some examples, the mathematical vectorization system 112 may represent each story dimension numerically individually and additionally or alternatively, the mathematical vectorization system 112 may represent multiple story dimensions numerically together. For example, for composite vectorization (e.g., when multiple dimensions are represented numerically together), a single numerical attribute (e.g., dimension value) may encompass multiple dimensions. For example, dimensions of genre (e.g., dystopian), protagonist (e.g., rebel), and target demographic (e.g., young adult) may each be given an individual numerical representation as well as a grouped numerical representation that encompasses the combination of the three dimensions (e.g., a young adult dystopian with a rebel protagonist). The determined story profiles and/or the user palette profiles may be stored, once determined, in a profile database 117. In some examples, user palette profiles may be updated iteratively as a user's tastes and habits evolve over time.

For example, the user engagement analysis system 110 may implement a specific, technically defined feedback mechanism by which user interaction signals as herein described are continuously processed and used to dynamically update the user palette profile vectors stored in the profile database 117. This iterative update process is not a mere abstract concept of “learning user preferences,” but rather a concrete technical operation in which new engagement metric data is ingested, processed to extract updated user engagement dimensions, and used to recompute or adjust the numerical dimension values of the user palette profile vector. For example, when a user completes a work and leaves a positive review, the story profile vector of that work is incorporated into the recomputation of the user palette profile vector, shifting the numerical values of the palette profile to more accurately reflect the user's current preferences. Conversely, negative engagement signals such as low ratings, skipped sections, or failure to complete a work are processed to adjust the user palette profile vector away from the dimension values associated with those negatively engaged with works. This iterative, signal-driven vector update mechanism produces a concrete technical result in the form of a dynamically maintained, numerically precise user palette profile vector that improves over time and enables increasingly accurate recommendation generation, representing a specific technical improvement over static preference profiles used in prior art recommendation systems.

The work recommendation system 118 may be configured to generate a recommendation for a new work for a user based on the user palette profile of that user and the story profiles of one or more available works, as stored in the profile database 117. The one or more available works may be of the one or more works 114. In some examples, the work recommendation system 118 may be a trained machine learning model that is trained to ingest the mathematical vectors included within the story profiles and the user palette profile in order to output a recommendation for a work corresponding to one of the story profiles that fits the user palette profile, for example based on vector similarity. In some examples, the work recommendation system 118 may be configured to cross-reference works that the user has already finished or started with the available works in order to recommend a work that is new to the user, thus mitigating recommendation of an already engaged with work. For example, one or more recommended works may be selected from a subset of the one or more works 114 that excludes works that the user has already engaged with (e.g., completed or started).

The work search system 119 may be configured to receive one or more user prompts and to search a database of story profiles that matches a user prompt. For example, a user may prompt the system, via voice or text, and the work search system 119 may employ one or more algorithms or processes to extract key elements of the request. For example, named entity recognition methods, keyword extraction and intent recognition methods, dependency parsing for structural understanding methods, machine learning algorithms, and/or the like may be employed to extract the key elements. The work search system 119 may then cross reference the identified key elements with vectors of story profiles stored in the profile database 117 to determine one or more matches. The matches may be ranked based on relevance and a corresponding user's palette profile to determine a best match, which may then be outputted to the user in response to the prompt.

The characterization and recommendation system 102 may be operably and/or communicatively coupled to the user input device 122 and a display device 120. In some examples, the display device 120 may be incorporated as part of the user input device 122. The user input device 122 may comprise one or more of a touchscreen, a keyboard, a mouse, a trackpad, a motion sensing camera, or other device configured to enable a user to interact with and manipulate data within the character and recommendation system 102. Further, in some examples, the user input device 122 may comprise a computing device comprising one or more processors and one or more memory storing devices, wherein the computing device incorporates an input device, such as a smart phone, a tablet, a laptop computer, a desktop computer, or the like. For example, the user read or listen to works via the user input device 122 and/or display device 120. The display device 120 may include one or more display devices utilizing virtually any type of technology. In some embodiments, display device 120 may comprise a smart phone screen and may display one or more GUIs. For example, the characterization and recommendation system 102 may be configured as part of a mobile application that comprises one or more GUIs through which users may interact with written works and/or audio narration versions of written works. As an example, the user input device 122 may include the display device 120 and may be a smart phone or tablet configured with a touchscreen display. Thus, the display device 120 may be combined with the processor(s) 104, the non-transitory memory 106, and/or the user input device 122 in a shared enclosure, or may be peripheral display devices and may comprise a monitor, touchscreen, projector, or other display device known in the art, which may enable the user to view the parsed text data in one or more GUIs and/or interact with the parsed text data via the one or more GUIs.

The user input device 122 may be communicatively and/or operably coupled to one or more text data repositories 126. The one or more text data repositories 126 may comprise any database accessible by the user input device 122 from which the works 114 may be obtained. As an example, the user input device 122 may obtain a written work from one of the one or more text data repositories 126 and may input the written work into the characterization and recommendation system 102 for story characterization. Further, audio narration versions may be inputted or otherwise generated before story characterization. For example, the characterization and recommendation system 102, via a GUI, may prompt the user to input text data from one or more sources, such as a folder of a file explorer application, an online storage medium, or the like. In some examples, the user input device 122 may also be configured to ingest audio data (e.g., user created audio data) and then text of the audio data may be generated via a speech-to-text application either within the user input device 122 and/or the character and recommendation system 102.

In some examples, both the characterization and recommendation system 102 and the user input device 122 may be communicatively and/or operably coupled to a network 124. For example, the characterization and recommendation system 102 may be configured to access the network 124 execute processes like mathematical vectorization or deployment of one or more machine learning models (e.g., via the work analysis system 108, the user engagement analysis system 110, and/or the work recommendation system 118). The user input device 122 may be coupled to the network 124 in order to communicate with the characterization and recommendation system 102, obtain works from the one or more text data repositories 126, and the like.

The mathematical vectorization technique employed by the mathematical vectorization system 112 produces a concrete and improved data structure that is specifically tailored to the technical problem of characterizing literary works for personalized recommendation. Unlike conventional tagging or categorical labeling systems, the composite vectorization technique herein described generates a multi-dimensional numerical representation that simultaneously captures both individual story dimensions and grouped combinations of dimensions in a single, computationally efficient data structure. For example, representing genre (e.g., dystopian), protagonist type (e.g., rebel), and target demographic (e.g., young adult) as both individual dimension values and as a single composite dimension value (e.g., “young adult dystopian with a rebel protagonist”) produces a richer and more precise story profile vector than any single-dimension representation could achieve. This composite vectorization approach results in a tangible improvement in the technical operation of the recommendation system itself, as the resulting vectors are more computationally efficient to compare, store, and retrieve from the profile database 117 than non-vectorized or purely categorical representations. The story profile vectors generated via this technique are a concrete, improved data structure that enables downstream machine learning models and similarity algorithms to operate with greater precision and reduced computational overhead, representing a specific technical improvement over prior art recommendation systems that rely on simple keyword matching or flat categorical tagging.

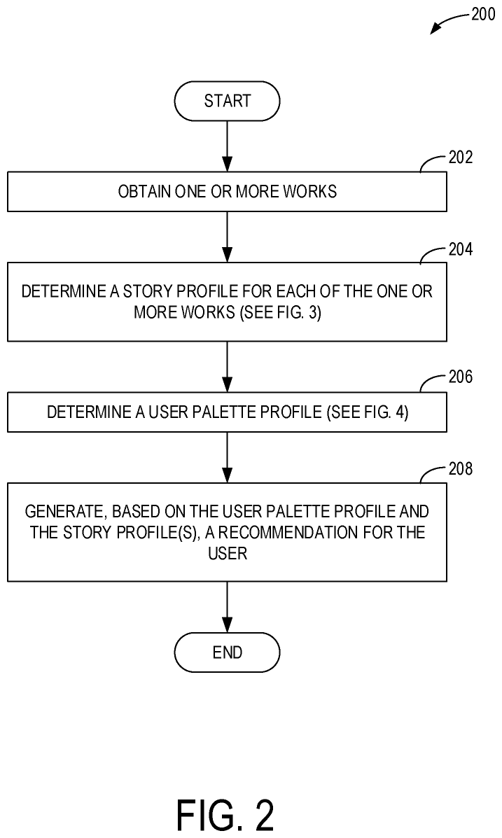

Turning now to FIG. 2, a high-level flowchart illustrating a method 200 for recommending a work to a user is shown. Method 200 may be executed by a processor of a characterization and recommendation system, such as the characterization and recommendation system 102 of FIG. 1. In some examples, some operations of method 200 may be stored in non-transitory memory of the characterization and recommendation system and executed by the processor of the characterization and recommendation system (e.g., one of the processor(s) 104 of FIG. 1).

At 202, method 200 includes obtaining one or more works. The one or more works may comprise one or both of a written work and a corresponding audio narration of the written work, in some examples. The one or more works may be uploaded to the characterization and recommendation system by users. In some examples, the written works may be uploaded by users and another system that is in communication with the characterization and recommendation system may generate audio narrations of the written works.

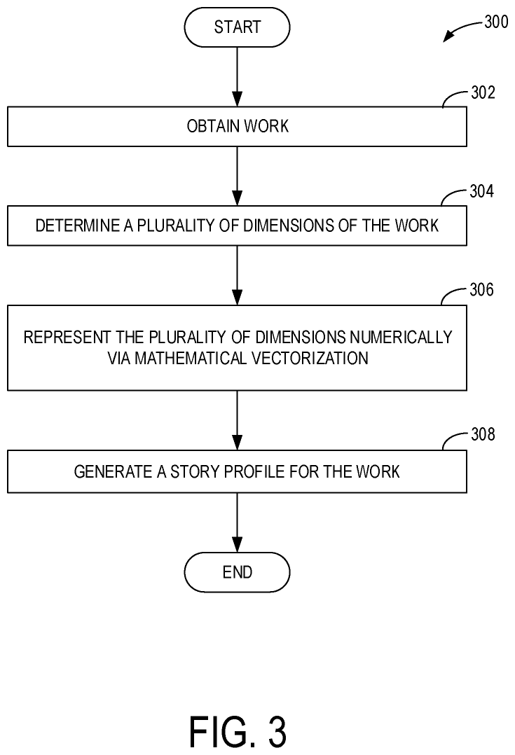

At 204, method 200 includes determining a story profile for each of the one or more works. As will be further described with respect to FIG. 3, determining the story profiles of the one or more works may comprise identifying one or more story dimensions, including content based dimensions or attributes and narration format based dimensions or attributes. The content based dimensions may relate to the text of the story and the narration format based dimensions may relate to how the audio narration is delivered.

As described above, the content based dimensions may include genre, subgenre(s), protagonist attributes, point of view, narrative structure, themes, setting, and target demographic. The narration format based dimensions may include audio narration style, audio narrator type, narration speed and style, sound design, and vocal performance style.

Each story profile may be determined via mathematical vectorization of the one or more story dimensions, including vectorization of one or both of individual dimensions or groups of dimensions. The vectorizations may then be embedded into a profile for performant retrieval for, for example, recommendation purposes and determination of user palette profiles.

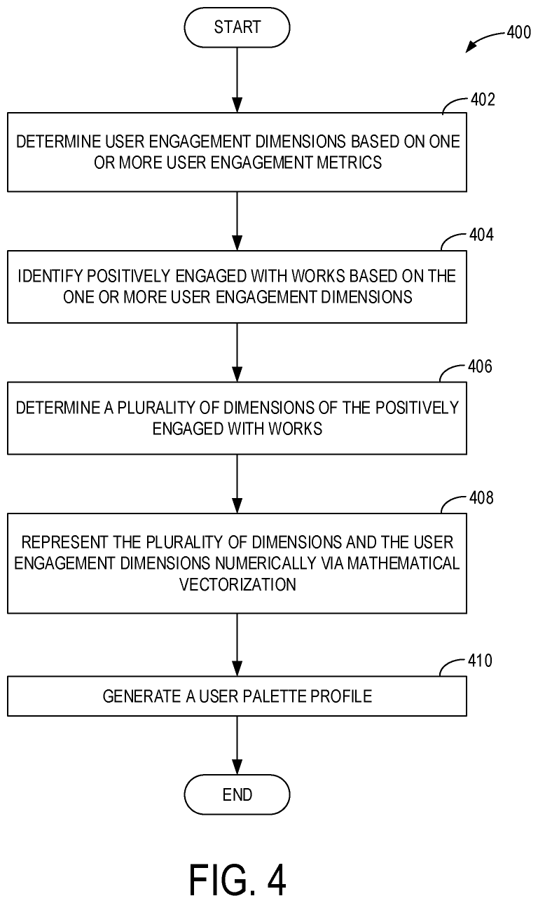

At 206, method 200 includes determining a user palette profile. As will be further described with respect to FIG. 4, for a given user, the user palette profile may be generated based on the story profiles and accompanying user engagement metrics. For example, user engagement metrics and engagement with certain types of works, works with certain narration styles, and the like, may be mathematically vectorized into a palette profile for that user. Thus, the palette profile may represent the types of works the user engages with (including based on the story dimensions of the works, the popularity of the works, and the listening context of the works) and the user's listening patterns.

At 208, method 200 includes generating, based on the user palette profile and the story profile(s), a recommendation for the user. As described above, a work recommendation system may comprise one or more trained machine learning models. Generating the recommendation may comprise deploying one or more trained machine learning models. The one or more trained machine learning models may be trained to ingest the user palette profile and the story profiles of the one or more works and generate a recommendation for the user of a work of the one or more works that fits the user palette profile. As an example, the model may identify a work with a story profile that includes one or more vectors that match the vectors of the user palette profile.

In an alternative example, mathematical techniques such as cosine similarity, collaborative filtering (e.g., matrix factorization, autoencoders, etc.), combinations thereof, or the like may be used to determine the work recommendation based on the vectorized story profiles and user palette profile.

The recommended work may thus be tailored to the specific user based on their listening habits and preferences, providing a more user specific experience that mitigates the information overload that comes with the available variety of works.

The work recommendation system 118 generates recommendations by performing vector similarity computations between the user palette profile vector and the story profile vectors stored in the profile database 117, producing a concrete and specific technical result: a ranked, user-specific recommendation output. Specifically, mathematical techniques such as cosine similarity measure the angular distance between the user palette profile vector and each story profile vector in a shared multi-dimensional vector space, yielding a quantifiable similarity score for each available work. This process is not merely an abstract comparison of preferences, but rather a specific, technically defined computational operation performed on structured numerical data objects (e.g., the embedded vectors generated by the mathematical vectorization system 112) that produces a measurable, reproducible output. The use of cosine similarity, collaborative filtering techniques such as matrix factorization or autoencoders, or combinations thereof, represents a specific technical implementation that operates on the concrete vector data structures generated by the system, and the output of this computation, such as a ranked list of recommended works, is a specific, tangible result that directly improves the user experience by reducing information overload. The technical improvement achieved by this approach is distinct from and superior to conventional recommendation approaches that rely on simple rule-based filtering or non-vectorized categorical matching, as the vector similarity approach enables nuanced, multi-dimensional comparisons across both content-based and narration-based story dimensions simultaneously.

Turning now to FIG. 3, a flowchart illustrating a method 300 for determining a story profile of a work is shown. Method 300 may be executed by a processor of a characterization and recommendation system, such as the characterization and recommendation system 102 of FIG. 1. In some examples, some operations of method 300 may be stored in non-transitory memory of the characterization and recommendation system and executed by the processor of the characterization and recommendation system (e.g., one of the processor(s) 104 of FIG. 1).

At 302, method 300 includes obtaining a work. The work may comprise one or both of a written work and a corresponding audio narration of the written work, in some examples. The work may be uploaded to the characterization and recommendation system by a user (e.g., an author. In some examples, the written works may be uploaded by users and another system that is in communication with the characterization and recommendation system may generate audio narrations of the written works.

At 304, method 300 includes determining a plurality of dimensions of the work. As described herein, the work may comprise story dimensions, including content-based dimensions and narration-based dimensions. The content-based dimensions may include genre (e.g., mystery, romance, fantasy, horror, dystopian, sci-fi, etc.), subgenres (e.g., enemies to lovers, psychological thriller, romantasy, etc.), story length (e.g., novel-length, short story, novella, etc.) mood/tone (e.g., dark, lighthearted, gritty, etc.), protagonist attributes (e.g., age, profession, hero/anti-hero, moral alignment, defining characteristics, etc.), point of view, narrative structure (e.g., linear, nonlinear, multi-timeline, epistolary, etc.), themes (e.g., identity crisis, survivor, forbidden love, revenge, etc.), setting (e.g., time period, social setting, physical location), and target demographic (e.g., young adult, adult, middle grade, etc.).

The narration-based dimensions may include audio narration style (e.g., single narrator, multi-cast, full audio drama, dual narrator, etc.), audio narrator type (e.g., human-like, AI-generated, male, female, a particular accent/dialect, etc.), narration speed and style (e.g., slow-paced, energetic, dramatic, deadpan, whispered, etc.), sound design (e.g., minimal extraneous sounds, music-enhanced, full sound effects, etc.), and vocal performance style (e.g., conversational, storytelling, theatrical, etc.).

The plurality of dimensions may be determined, in one example, by a trained machine learning model. For example, a machine learning model may be trained to ingest a work, for example in both text and audio form, and determine attributes of the work, including what genre the work is, the target demographic of the work, and the like. The machine learning model may be deployed to identify the plurality of dimensions of the work of interest. In another example, the plurality of dimensions may be user inputted or determined via a natural language processing algorithm like a word embedding algorithm or similar algorithm.

At 306, the method 300 includes representing the plurality of dimensions numerically via mathematical vectorization. For example, the work may be represented as a vector with all its numerical attributes. For example, each numerical attribute may represent either a single dimension of the plurality of dimensions or a group of dimensions of the plurality of dimensions. For example, the genre of the work (e.g., fantasy) may be represented as a first dimension value, the target demographic (e.g., young adult) may be represented as a second dimension value, and the combination of the genre and the target demographic (e.g., young adult fantasy) may be represented as a third dimension value. The vector of the work may comprise all the dimension values thereof.

At 308, the method 300 includes generating a story profile for the work. The story profile, in some examples, may be the vector that comprises all the dimension values of the work as determined. In other examples, multiple vectors may be generated for the work and the story profile may comprise the multiple vectors. The story profile may thus be a numerical representation of the attributes of the work.

Turning to FIG. 4, a flowchart illustrating a method 400 for generating a user palette profile is shown. Method 400 may be executed by a processor of a characterization and recommendation system, such as the characterization and recommendation system 102 of FIG. 1. In some examples, some operations of method 400 may be stored in non-transitory memory of the characterization and recommendation system and executed by the processor of the characterization and recommendation system (e.g., one of the processor(s) 104 of FIG. 1).

At 402, method 400 includes determining one or more user engagement dimensions based on one or more user engagement metrics. For example, the user engagement dimensions may comprise general engagement (e.g., number of plays, reviews ratings, likes, social shares, and the like); engagement metrics like completion rate, replays, and skipped sections, listening patterns (e.g., time of day, mood-based listening habits, binge listener vs casual listener, etc.), user-curated lists and playlists (e.g., community generated lists that the user engages with and/or user-generated lists), discoverability engagement (e.g., engagement with trending/mainstream works vs rarely listened to works), and listening context.

The one or more user engagement metrics may comprise interactions of the user with works. For example, metrics like which works the user finished, which works the user did not finish, user-inputted likes, user-inputted reviews, which works the user puts in playlists, what time of day the user listens/reads and what types of works the user engages with at what times, and more. These metrics may be used to determine the user engagement dimensions, which include both positive engagement dimensions and negative engagement dimensions. In some examples, a trained machine learning model may be deployed to generate the one or more user engagement dimensions based on the user engagement metrics. For example, the machine learning model may be trained to ingest user engagement metrics like those outlined above and generate a plurality of engagement dimensions for the user.

At 404, method 400 includes identifying, from the user engagement dimensions, positively engaged with works. As described herein, in some examples, the engagement dimensions may inform which works the user positively engages with. For example, positive engagement may describe a positive review, a positive recommendation, completion of the work, replaying the work, and the like.

At 406, method 400 includes determining a plurality of dimensions of the positively engaged with works. The positively engaged with works may be works for which story profiles that encompass vectorizations of dimensions of the work have been generated or are generated substantially at the same time.

At 408, method 400 includes representing the plurality of dimensions associated with the positively engaged with works and the user engagement dimensions numerically via mathematical vectorization. For example, the dimensions of positively engaged with work and the user engagement dimensions may be represented as a vector with all the relevant numerical attributes. For example, each numerical attribute may represent either a single dimension of the plurality of dimensions or a group of dimensions of the plurality of dimensions. For example, a genre that the user common engages with (e.g., fantasy) may be represented as a first dimension value, a target demographic that the user commonly engages with (e.g., young adult) may be represented as a second dimension value, and the combination of the genre and the target demographic (e.g., young adult fantasy) may be represented as a third dimension value. As a further example, a timeframe of engagement (e.g., listening/reading in the morning) may be represented as a first dimension value, a discoverability (e.g., infrequently engaged with work) may be represented as a second dimension value, and the combination of the two (e.g., listening/reading to infrequently engaged with works in the morning) may be represented as a third dimension value. The vector of the user palette may encompass all dimension values, thereby representing the types of work the user most commonly engages with in a positive way and how the user engages with those works.

At 410, method 400 includes generating a user palette profile. The user palette profile, in some examples, may be the vector that comprises all the dimension values of the user engagement, including the types of work the user positively engages with and how they engage as is herein described, as determined. In other examples, the user palette profile may comprise the multiple vectors. The user palette profile may thus be a numerical representation of the work attributes that the user gravitates towards and their tendencies for how they engage with such works.

As described with respect to FIG. 3, the user palette profile and the plurality of story profiles may be used to generate a recommendation for a work at the user-end that is specific to the user. For example, based on the attributes of a story and a user's specific palette, the story may or may not be recommended. As an example, the user palette profile and the plurality of story profiles may be inputted into a trained machine learning model that maps the vectorizations as determined in order to identify one of the works as a good recommendation for the user based on the user's palette. This may, for example, be based on a comparison of vectors, whereby a story with a profile that comprises a vector with dimension values with a high percentage of overlap with the vector of dimension values of the user's palette profile is considered a good recommendation for that user.

In some examples, the determination of the recommendation may take in to account other factors as well. For example, a similarity index between users may increase the likelihood of a story being recommended to the user when a similar user positively engaged with the story. As another example, similarity indexes between stories may be used, whereby stories that are engaged with positively by similar users may be recommended in a cohesive fashion. For example, the user may positively engage with a first story and thus a second story that was positively engaged with by other users who also positively engaged with the first story may be recommended to the user. These types of indexes may also be represented via mathematical vectorization to allow the machine learning model that recommends works to ingest them easily.

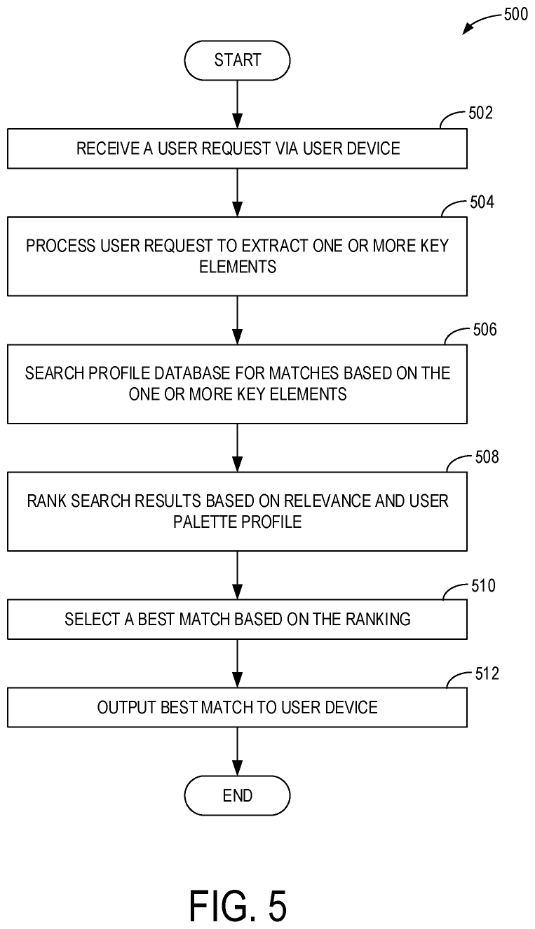

Turning now to FIG. 5, a method 500 for searching a profile database in response to a user prompt is shown. Method 500 may be executed by a processor of a characterization and recommendation system, such as the characterization and recommendation system 102 of FIG. 1. In some examples, some operations of method 500 may be stored in non-transitory memory of the characterization and recommendation system and executed by the processor of the characterization and recommendation system (e.g., one of the processor(s) 104 of FIG. 1).

At 502, method 500 includes receiving a user request via a user device. The user request may be a voice prompt or a text prompt for a recommendation. As a non-limiting example, a user may input a request such as “find me a fantasy story that is less than 10 minutes with a funny heroine”. The user device may be an example of the user input device 122. For example, the characterization and recommendation system may be deployed as a mobile application accessible via a smart phone, where the user may input requests in text form or audio form to the mobile application.

At 504, method 500 includes processing the user request to extract one or more key elements. For example, the user request may be processed according to one or more natural language processing algorithms, such as a named entity recognition algorithm, a keyword extraction and intent recognition algorithm, a dependency parsing for structural understanding method, and/or the like, or via a trained machine learning model. The one or more key elements may be similar to story dimensions herein described. For example, for the request of “find me a fantasy story that is less than 10 minutes with a funny heroine”, the key elements may include genre: fantasy, length: less than 10 minutes, and protagonist: heroine, funny.

At 506, method 500 includes searching a profile database for matches based on the one or more key elements. As herein described, determined story profiles may be stored in the profile database. Each story profile may comprise a plurality of vectors that represent the story dimensions. The one or more key elements, which may be categorized under the same story dimension categories as the story profile dimensions, may be cross-referenced to the vectors of each story profile for identification of matches. The matches may include story dimensions that match the identified key elements.

At 508, method 500 include ranking search results based on relevance and a user palette profile. As an example, the user palette profile for the user that inputted the user request may suggest that the user tends to listen to or read works with one or more additional or other dimensions. For example, the user request may include elements that correspond to a first subset of story dimensions (e.g., genre, duration/length, and protagonist type) while the user palette profile may include preferences and/or tendencies for a superset of story dimensions, the superset including the dimensions of the first subset. Each story profile may also include a dimension for most or each of the superset of story dimensions. The stories that were matched to the one or more key elements of the request may be ranked and/or narrowed based on the remaining dimensions of the superset that are not included in the request (e.g., not in the first subset). As an example, the key elements may include dimensions of genre, duration/length, and protagonist type. The user palette profile may suggest user preferences for one or more other dimensions such as point of view, setting, and target demographic. The stories identified as matches may be ranked based on their correspondence to the one or more other dimensions. For example, the user palette profile may indicate that the user prefers young adult fantasy over adult fantasy and thus story matches that include vectors for young adult may be ranked higher than story matches that include vectors for adult.

Other factors suggesting relevance of stories may also be considered in the ranking. For example, a popularity of the work, whether the work has been recommended to the user before and the user's response to this prior recommendation (e.g., partial listen, no interaction, etc.), and more may be considered when determining the ranking.

At 510, method 500 includes selecting a best match based on the ranking. For example, a top ranked match may be considered the best match.

At 512, method 500 includes outputting the best match to the user device. For example, the best match may be outputted in a pop-up graphical user interface on the user device, in a response panel that corresponds to the user request, or similar. In some examples, the best match start playing in audio form upon identification. The user may be able to interact with the best match recommendation. For example, the user may reject the recommendation, in which case a second top match may be recommended second. The user's interactions with the best match (e.g., completion rate, positive or negative review, etc.) may be fed back into the system for adjustment of the user palette profile.

The technical effect of the systems and methods herein described is that each user of the characterization and recommendation system may be provided recommendations that are targeted or tailored specifically to them based on their interactions with other works. For example, each work may have attributes defined therefor and a user may have attributes that represent the types of works they gravitate towards and how they engage with those works. By representing these attributes or dimensions via mathematical vectorization, the story profiles and user palette profiles may be more easily fed into a trained machine learning model for recommendation generation.

The disclosure also provides support for a story recommendation system, comprising: a processor communicably coupled to non-transitory memory storing instructions that when executed cause the processor to: receive one or more works, determine story profiles of the one or more works via vectorization of one or more story dimensions of the one or more works, determine, for a user, a user palette profile, and generate a recommendation for a work of the one or more works for the user based on vector similarity between the story profiles and the user palette profile. In a first example of the system, to the one or more story dimensions comprise content and narration dimensions. In a second example of the system, optionally including the first example, the processor is configured to deploy a trained machine learning model to define the one or more story dimensions. In a third example of the system, optionally including one or both of the first and second examples: the one or more works each comprise a written work and an audio narration, and the one or more story dimensions comprises one or more of content-based dimensions determined based on the written work of a given work and narration-based dimensions determined based on the audio narration of the given work. In a fourth example of the system, optionally including one or more or each of the first through third examples, to determine the user palette profile of the user, the processor is configured to: define one or more user engagement dimensions and a plurality of story dimensions of works that the user positively engaged with, and represent the one or more user engagement dimensions and the plurality of story dimensions numerically via mathematical vectorization. In a fifth example of the system, optionally including one or more or each of the first through fourth examples, to define the one or more user engagement dimensions, the processor is configured to deploy a trained machine learning model. In a sixth example of the system, optionally including one or more or each of the first through fifth examples,: the story profiles and the user palette profile are vectors, and to generate the recommendation for the work for the user, the processor is configured to deploy a trained machine learning model that is configured to ingest the vectors and output the recommendation based thereon based on the vector similarity.

The disclosure also provides support for a method, comprising: obtaining one or more works, wherein each of the one or more works comprises a written work and a corresponding audio narration, determining one or more story profiles for the one or more works, wherein one or more of the one or more story profiles are determined via mathematical vectorization of a plurality of story dimensions of a corresponding work, wherein the mathematical vectorization comprises a composite vectorization of individual and grouped dimensions, determining a user palette profile for a user based at least in part on the one or more story profiles, and generate a recommendation for the user based on the user palette profile and the one or more story profiles. In a first example of the method, determining the plurality of story dimensions comprises deploying a trained machine learning model. In a second example of the method, optionally including the first example, determining the user palette profile comprises: determining one or more user engagement dimensions based on one or more user engagement metrics, identifying one or more positively engaged with works of the one or more works based on the one or more user engagement dimensions, determining a plurality of story dimensions of the one or more positively engaged with works, and representing the plurality of story dimensions and the one or more user engagement dimensions numerically via mathematical vectorization. In a third example of the method, optionally including one or both of the first and second examples, determining the one or more user engagement dimensions comprises deploying a trained machine learning model. In a fourth example of the method, optionally including one or more or each of the first through third examples, the method further comprises: receiving a user request for a work recommendation, determining one or more key elements of the user request, determining, of the one or more story profiles for the one or more works, one or more matches, and determining a best match of the one or more matches, wherein the recommendation for the user is the best match. In a fifth example of the method, optionally including one or more or each of the first through fourth examples, determining, of the one or more story profiles for the one or more works, one or more matches comprises cross-referencing one or more story dimensions of one or more of the one or more story profiles with the one or more key elements. In a sixth example of the method, optionally including one or more or each of the first through fifth examples, determining the best match of the one or more matches comprises ranking the one or more matches based on at least the user palette profile.

The disclosure also provides support for a method for a story recommendation system, comprising: obtaining one or more works, determining story profiles for the one or more works, determine, for a user, a user palette profile based on one or more positive engagement signals and one or more negative engagement signals, generate a recommendation for the user based on the user palette profile and the story profiles of the one or more works. In a first example of the method, the one or more positive engagement signals and the one or more negative engagement signals are determined based on user engagement metrics comprising work-specific metrics and community metrics. In a second example of the method, optionally including the first example, the one or more positive engagement signals and the one or more negative engagement signals comprise time-of-day listening patterns, listening context, listening session behavior, and work discoverability preferences. In a third example of the method, optionally including one or both of the first and second examples, the recommendation comprises one or more recommended works selected from a subset of the one or more works, wherein the subset of the one or more works excludes one or more works that the user has already engaged with. In a fourth example of the method, optionally including one or more or each of the first through third examples, determining a story profile for a work of the one or more works comprises: determining a plurality of dimensions of the work, and generating a plurality of vectors for the work based on the plurality of dimensions via mathematical vectorization, wherein the story profile comprises the plurality of vectors and is a numerical representation of the plurality of dimensions of the work. In a fifth example of the method, optionally including one or more or each of the first through fourth examples, determining the user palette profile based on the one or more positive engagement signals and the one or more negative engagement signals comprises generating a plurality of vectors based on the one or more positive engagement signals and one or more negative engagement signals.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A story recommendation system, comprising:
a processor communicably coupled to non-transitory memory storing instructions that when executed cause the processor to:
receive one or more works;
determine story profiles of the one or more works via vectorization of one or more story dimensions of the one or more works;
determine, for a user, a user palette profile; and
generate a recommendation for a work of the one or more works for the user based on vector similarity between the story profiles and the user palette profile.

2. The story recommendation system of claim 1, wherein to the one or more story dimensions comprise content and narration dimensions.

3. The story recommendation system of claim 1, wherein the processor is configured to deploy a trained machine learning model to define the one or more story dimensions.

4. The story recommendation system of claim 1, wherein:
the one or more works each comprise a written work and an audio narration; and
the one or more story dimensions comprises one or more of content-based dimensions determined based on the written work of a given work and narration-based dimensions determined based on the audio narration of the given work.

5. The story recommendation system of claim 1, wherein to determine the user palette profile of the user, the processor is configured to:
define one or more user engagement dimensions and a plurality of story dimensions of works that the user positively engaged with; and
represent the one or more user engagement dimensions and the plurality of story dimensions numerically via mathematical vectorization.

6. The story recommendation system of claim 5, wherein to define the one or more user engagement dimensions, the processor is configured to deploy a trained machine learning model.

7. The story recommendation system of claim 1, wherein:
the story profiles and the user palette profile are vectors; and
to generate the recommendation for the work for the user, the processor is configured to deploy a trained machine learning model that is configured to ingest the vectors and output the recommendation based thereon based on the vector similarity.

8. A method, comprising:
obtaining one or more works, wherein each of the one or more works comprises a written work and a corresponding audio narration;
determining one or more story profiles for the one or more works, wherein one or more of the one or more story profiles are determined via mathematical vectorization of a plurality of story dimensions of a corresponding work, wherein the mathematical vectorization comprises a composite vectorization of individual and grouped dimensions;
determining a user palette profile for a user based at least in part on the one or more story profiles; and
generate a recommendation for the user based on the user palette profile and the one or more story profiles.

9. The method of claim 8, wherein determining the plurality of story dimensions comprises deploying a trained machine learning model.

10. The method of claim 8, wherein determining the user palette profile comprises:
determining one or more user engagement dimensions based on one or more user engagement metrics;
identifying one or more positively engaged with works of the one or more works based on the one or more user engagement dimensions;
determining a plurality of story dimensions of the one or more positively engaged with works; and
representing the plurality of story dimensions and the one or more user engagement dimensions numerically via mathematical vectorization.

11. The method of claim 10, wherein determining the one or more user engagement dimensions comprises deploying a trained machine learning model.

12. The method of claim 8, further comprising:
receiving a user request for a work recommendation;
determining one or more key elements of the user request;
determining, of the one or more story profiles for the one or more works, one or more matches; and
determining a best match of the one or more matches, wherein the recommendation for the user is the best match.

13. The method of claim 12, wherein determining, of the one or more story profiles for the one or more works, one or more matches comprises cross-referencing one or more story dimensions of one or more of the one or more story profiles with the one or more key elements.

14. The method of claim 12, wherein determining the best match of the one or more matches comprises ranking the one or more matches based on at least the user palette profile.

15. A method for a story recommendation system, comprising:
obtaining one or more works;
determining story profiles for the one or more works;
determine, for a user, a user palette profile based on one or more positive engagement signals and one or more negative engagement signals;
generate a recommendation for the user based on the user palette profile and the story profiles of the one or more works.

16. The method of claim 15, wherein the one or more positive engagement signals and the one or more negative engagement signals are determined based on user engagement metrics comprising work-specific metrics and community metrics.

17. The method of claim 15, wherein the one or more positive engagement signals and the one or more negative engagement signals comprise time-of-day listening patterns, listening context, listening session behavior, and work discoverability preferences.

18. The method of claim 15, wherein the recommendation comprises one or more recommended works selected from a subset of the one or more works, wherein the subset of the one or more works excludes one or more works that the user has already engaged with.

19. The method of claim 15, wherein determining a story profile for a work of the one or more works comprises:
determining a plurality of dimensions of the work; and
generating a plurality of vectors for the work based on the plurality of dimensions via mathematical vectorization, wherein the story profile comprises the plurality of vectors and is a numerical representation of the plurality of dimensions of the work.

20. The method of claim 15, wherein determining the user palette profile based on the one or more positive engagement signals and the one or more negative engagement signals comprises generating a plurality of vectors based on the one or more positive engagement signals and one or more negative engagement signals.
